(19) United States
(12) Patent Application Publication
(10) Pub. No.: US 2020/0188710 A1
(43) Pub. Date: Jun. 18, 2020

(54) FALL PROTECTION ANCHOR

(71) Applicant: Ronald Newman Roseveare, JR., Lynchbug, VA (US)

(72) Inventor: Ronald Newman Roseveare, JR., Lynchbug, VA (US)

(21) Appl. No.: 16/218,120

(22) Filed: Dec. 12, 2018

(51) Int. Cl. A62B 35/00

(52) U.S. Cl. CPC A62B 35/0068; A62B 35/0037

(57) ABSTRACT

A fall protection anchor having a base with an upstanding member having an opening that permits attachment of a body harness lanyard. In order to provide optimal increased load bearing resistance when a force is applied to the fall protection anchor from varying directions, the upstanding member is angularly orientated relative to the longitudinal axis of the base. An elliptical attachment opening is formed in the upstanding central portion that provides a self-positioning feature where a lanyard connecting device can be secured to the fall protection anchor and rotated in any direction 360 degrees around the anchor without binding of the lanyard; or improper loading of a connecting device gate.

### CROSS-REFERENCE TO RELATED APPLICATIONS

This application claims the benefit of U.S. Provisional Patent Application Ser. No. 62/708,602 filed Dec. 15, 2017, which application is incorporated in its entirety.

### FIELD OF THE INVENTION

The present invention relates to the field of roofing and in particular to an anchor used in a fall protection system.

### BACKGROUND OF THE INVENTION

Falls are the leading cause of work-related injuries and deaths among roofers. High elevations, unprotected roof edges and steep slopes all pose fall risks for roofers. Not only roofers but other individuals such as masonry and chimney workers, service technicians, equipment installers or any person exposed to a potential fall of six feet or more from a lower level incurs a serious risk of injury when working from such heights. Employers must provide a fall protection system that meets Occupational Safety and Health Administration (OSHA) requirements for workers exposed to such fall risks. One form of fall protection is a personal fall arrest system (PFAS). A PFAS typically consists of an anchor, a harness attached to a worker, and a lifeline or lanyard. When used properly, these systems will arrest a fall and prevent the worker from contacting a lower level. In addition, the anchor for a fall arrest system must be capable of supporting 5,000 pounds. Most of the time, existing roofs will not have permanent anchors available for use as fall protection and it is up to a qualified person to install an anchor for a fall arrest system.

### BRIEF SUMMARY OF THE INVENTION

It is an object of the present invention to provide a PFAS anchor that employs no moving parts, is easily installed and meets the aforementioned safety requirements. An anchor is provided that consists of a base member having an upstanding central portion with an opening used to attach a connecting device, such as a snap hook or carabiner, attached to a lifeline or lanyard. The upstanding central portion is preferably angularly orientated relative to the longitudinal axis of the base member. This provides optimal increased load bearing resistance when a force is applied to the roof anchor from varying directions.

It is another object of the present invention to provide an anchor with fall protection in any direction 360 degrees around the anchor. The upstanding central portion is formed to include an arch shaped top edge. A generally elliptical attachment opening is formed in the upstanding central portion such that the upstanding central portion arch shaped top edge has a curvature similar to the curvature of the elliptical attachment opening. This provides a self-positioning feature whereby the lifeline or lanyard connecting device (e.g. snap hook or carabiner) can be secured to the fall protection anchor and rotated in any direction 360 degrees around the anchor without binding of the lifeline or lanyard; or improper loading of the connecting device gate.

It is another object of the present invention to provide a versatile anchor that is also designed to be attached to either a roof substructure or a masonry construction. Masonry walls are typically constructed of brick, concrete, adobe, gypsum block, stone or similar materials, laid in courses and bound together by mortar joints between the courses. When attaching a device to such masonry construction it is often desirable to use the mortar joints to secure fasteners rather the brick. Drilling directly into the mortar joints is easier to repair, less difficult than drilling into the brick and less likely to crack the brick. The anchor base member includes a first section and a second section on opposite sides of the upstanding central portion. Each first section and second section include a hole that is spaced apart from one another a distance equal to the spacing of a mortar joint in adjacent courses of a masonry construction. In this manner the fall protection anchor can be mounted to a roof substructure or a masonry construction.

Accordingly, the present invention provides an improved fall protection anchor. These and other advantages of the present invention will readily be apparent as described hereafter.

### BRIEF DESCRIPTIONS OF THE DRAWINGS

FIG. 1 is a perspective view of a preferred embodiment of the fall protection anchor.

FIG. 2 is a top view of a preferred embodiment of the fall protection anchor.

FIG. 3 is a preferred embodiment the fall protection anchor prior to assembly.

FIGS. 4A-4F are perspective views of 360 degree mobility around a preferred embodiment of the fall protection anchor.

FIG. 5 is a perspective view of a preferred embodiment of the fall protection anchor attached to a masonry construction.

FIG. 6 is a view of a preferred embodiment of the fall protection anchor attached to a roof.

### DETAILED DESCRIPTION OF THE INVENTION

The detailed description set forth below in connection with the appended drawings is intended as a description of the present preferred embodiments of the invention and is not intended to represent the only forms in which the present invention may be constructed or utilized. It is to be understood, however, that the same or equivalent functions may be accomplished by different embodiments that are also intended to be encompassed within the spirit and scope of the invention.

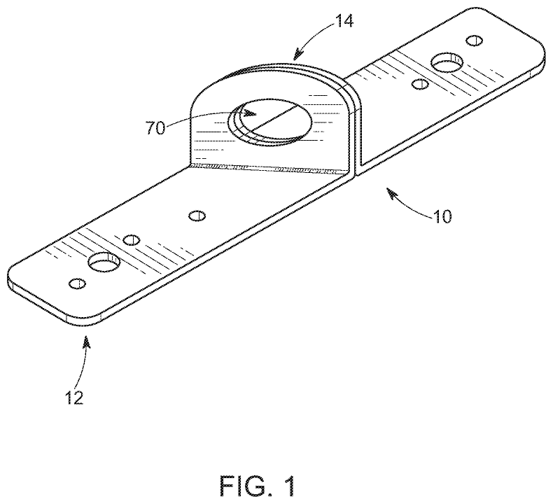

Referring to FIG. 1, the preferred embodiment of the fall protection anchor 10 is shown which includes a base member 12 and an upstanding central portion 14. As shown in FIG. 1, upstanding central portion 14 is preferably angularly orientated relative to the longitudinal axis of the base member 12. This angular orientation relative to the longitudinal axis of base member 12 provides optimal increased load bearing resistance when a force is applied to the roof anchor from varying directions. Upstanding central portion 14 includes an elliptical opening 70 adapted to receive a connecting device attached to a lanyard of a harness system. Fall protection anchor 10 may be made of any suitable material such as metal, plastic, ceramic or synthetic composite. Elliptical opening 70 permits a self-adjusting positioning feature as will be later explained herein.

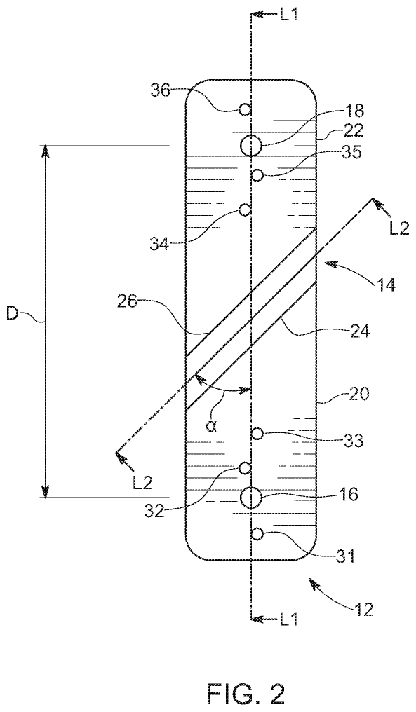

As shown in FIG. 2, base member 12 includes a first section 20 and a second section 22. Extending from the first section 20 is a first connecting portion 24 and a second connecting portion 26 extends from the second section 22. Each of the first connecting portion 24 and second connecting portion 26 form the upstanding central portion 14. FIG. 2 shows the first section 20 constructed to have a series of primary holes 31, 32, 33 and at least one secondary hole 16. The primary holes 31, 32 and 33 have a diameter capable of receiving a fastener, such as a bolt or screw, used to attach the fall protection anchor 10 to a roof substructure Similarly, the second section 22 includes a series of primary holes 34, 35, 36 and at least one secondary hole 18. The second section 22 series of primary holes 34, 35, 36 also have a diameter capable of receiving a fastener for attaching the fall protection anchor 10 to a roof substructure. The first section 20 secondary hole 16 spaced a distance “D” apart from second section 22 secondary hole 18. In this manner the fall protection anchor is attached to a substructure on opposite sides of the upstanding central portion 14 so that loading forces are resisted from any direction 360 degrees around the fall protection anchor 10.

When drilling holes into roofing or other structures it is often undesirable to drill a series of aligned holes in the structure. Axially aligned holes provide a line of weakness prone to failure and is particularly disadvantageous when working with wood as wood is highly susceptible to cracking along the grain. In a particular example of roof rafters, they are typically boards with a width of approximately 1 and ½ inches. It is also important that the holes be close to the centerline of the board so that the fastener is securely embedded within the board. When attaching fall protection anchor 12 to a roof substructure having rafters or boards, primary holes 31, 32, 33, 34, 35 and 36 are non-axially aligned such that longitudinal axis L1 is tangential to each of primary holes 31, 32, 33, 34, 35 and 36. This provides optimal attachment of fall protection anchor 10 to the roof rafter boards. While the preferred embodiment is constructed with primary holes 31, 32, 33, 34, 35 and 36 non-axially aligned for optimal attachment of fall protection anchor 10, it will be appreciated by one skilled in the art that primary holes 31, 32, 33, 34, 35 and 36 may be axially aligned or arranged in any pattern desired that facilitates attachment to a roof substructure.

Each of the primary holes 31, 32, 33, 34, 35 and 36 are preferably 0.21 inches in diameter and each of secondary holes 16, 18 are 0.375 inches diameter. While six primary holes and two secondary holes are depicted, this is for illustrative purposes only. Each of sections 20 and 22 may be constructed to have only a secondary hole 16 and 18 with the primary holes 31, 32, 33, 34, 35 and 36 eliminated. Alternatively, each of sections 20 and 22 may be constructed to have only primary holes 31, 32, 33, 34, 35 and 36 with the secondary holes 16 and 18 eliminated. One skilled in the art would appreciate the number and diameter of holes can also be varied as needed to stably attach the fall protection anchor 10. As shown in FIG. 2, the longitudinal axis L2 of upstanding central portion 14 is angularly orientated relative to the base member 12 such that the longitudinal axis L2 intersects the longitudinal axis L1 of base member 12 at an acute angle “α”. In a preferred embodiment acute angle “α” is approximately 45 degrees for optimal load bearing resistance. While an acute angle “α” of approximately 45 degrees is preferred, one skilled in the would recognize the angle “α” could be varied between 0 degrees and 90 degrees.

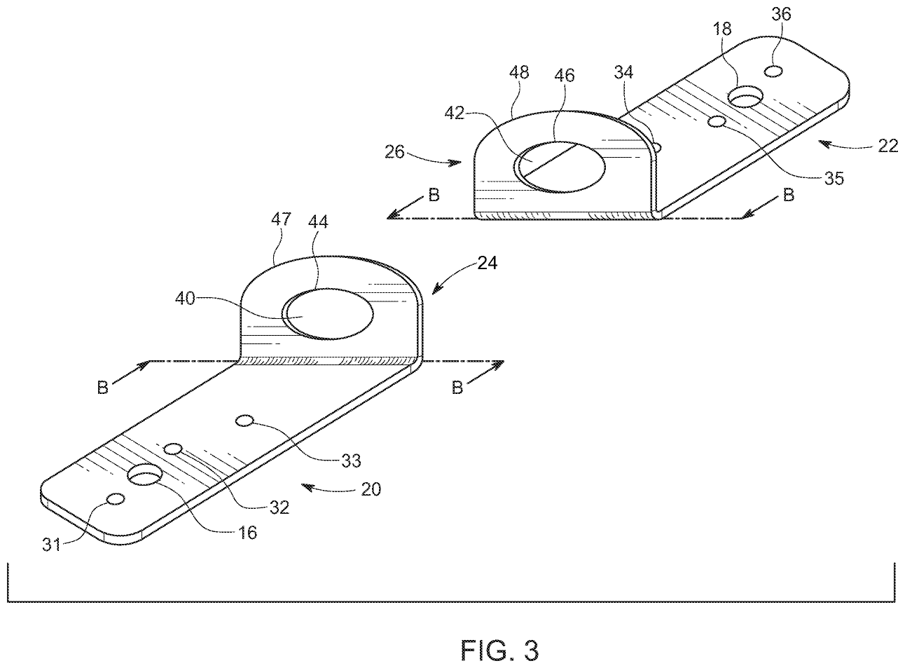

FIG. 3 depicts a preferred embodiment of forming fall protection anchor 10. First section 20 is formed with a first connecting portion 24 extending laterally and angularly outward relative to the longitudinal axis of first section 20. First connecting portion 24 is constructed to include an opening 40 having an elliptical outer surface 44. The outer surface of first connecting portion 24 includes an arch shaped top edge 47 along portion thereof, having a curvature similar to the curvature of elliptical outer surface 44. The arch shaped top edge 47 is smoothly curved between opposite ends and equidistantly spaced from the elliptical outer surface 44 along the arc length of the arch shaped top edge 47. FIG. 3 also depicts second section 22 having a second connecting portion 26 extending laterally and angularly outward relative to the longitudinal axis of second section 22. Second connecting portion 26 is constructed to include an opening 42 having an elliptical outer surface 46. The outer surface of second connecting portion 26 includes an arch shaped top edge 48 along at least a portion thereof, having a curvature similar to the curvature elliptical outer surface 46. The arch shaped top edge 48 is smoothly curved between opposite ends and equidistantly spaced from the elliptical outer surface 46 along the arc length of the arch shaped top edge 48. First section 20 and first connecting portion 24 are substantially mirror images of second section 22 and second connecting portion 26. First connecting portion 24 is bent vertically upward along line “B” perpendicular to first section 20 and second connecting portion 26 is bent vertically upward along line “B” perpendicular to second section 22. In this embodiment of forming fall protection anchor 10, first section 20 and first connecting portion 24 are made of a metal material such as 7 gauge stainless steel. Second section 22 and second connecting portion 26 is also made of a metal material such as 7 gauge stainless steel. The bent first connecting portion 24 is joined to the bent second connecting portion 26 to form the fall protection anchor 10 shown in FIGS. 1 and 2. Any conventional manner of joining first connecting portion 24 to second connection portion 26 may be used such as welding, soldering or brazing.

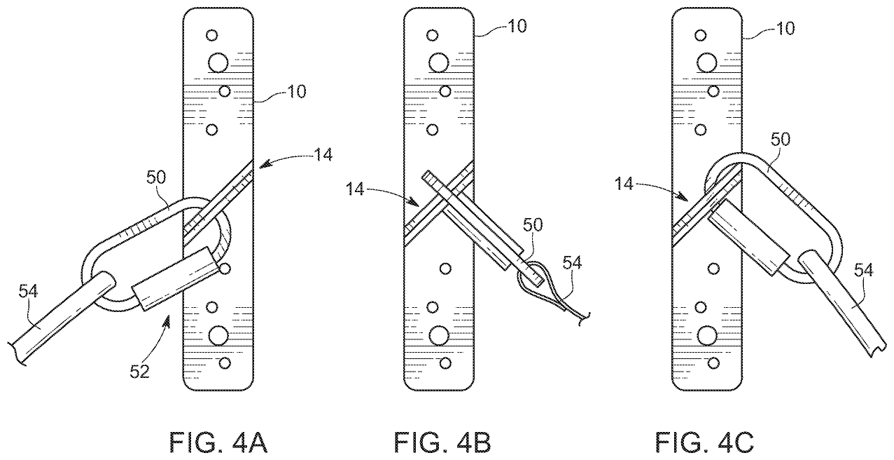

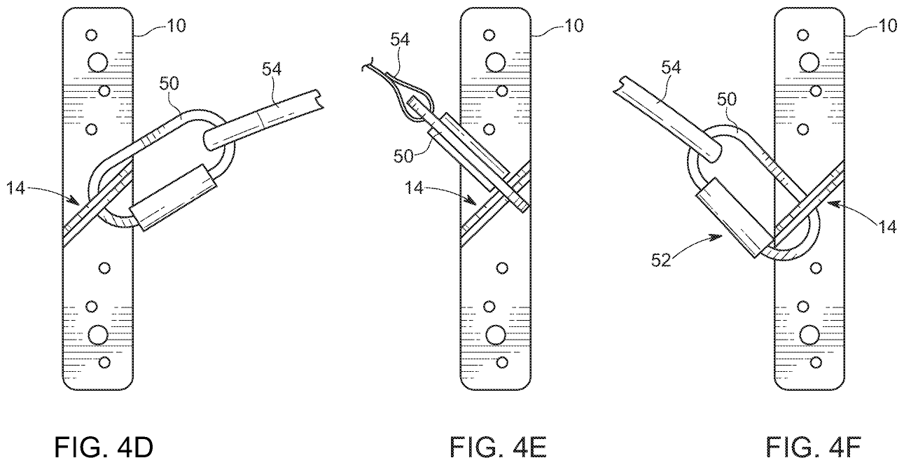

FIGS. 4A-4F depict 360 degree mobility around the fall protection anchor 10 and the self-positioning feature of the present invention. Referring to FIG. 4A a lanyard 54 is secured to a connecting device 50. Connecting device 50 includes a gate 52 that functions as a closure permitting opening and closing of the connecting device 50. While the connecting device 50 depicted is a carabineer clip, one skilled in the art would appreciate other connecting devices could be used such as snap hooks or trigger hooks. In this fashion connecting device 50 is attached to upstanding central portion 14 of fall protection anchor 10. A worker exposed to a fall risk typically wears a body harness having lanyard 54 secured to a connecting device 50 that is attached to fall protection anchor 10. In this manner a worker is rigged to prevent free falling. It is also necessary that a worker be free to move in any direction around the fall protection anchor 10 to complete tasks. In this regard FIG. 4A represents a first position and as a worker moves in a counter-clockwise direction around fall protection anchor 10, the lanyard 54 is also shown as moving in a counter-clockwise position from FIG. 4A to FIG. 4B and FIG. 4C. It is also evident from the position of FIG. 4A, as the worker begins to move counter-clockwise around fall protection anchor 10, connecting device 50 begins to rotate and becomes vertical as shown in FIG. 4B. Upon further counter-clockwise motion to the position of FIG. 4C, the connecting device 50 rotates from the vertical position shown in FIG. 4B to a side position shown in FIG. 4C. It is important to note that in all the positions of FIG. 4A, FIG. 4B and FIG. 4C an axial force applied along lanyard 54 loads the outer ring of connecting device 50 and not connecting device gate 52. This prevents improper loading of the connecting device gate 52, binding of the lanyard 54 and rotational locking of the connecting device 50 within the upstanding member 14.

Further counter-clockwise movement of lanyard 54 about fall protection anchor 10 is emulated in FIGS. 4D-4F. In the position shown in FIG. 4D it is readily evident connecting device 50 freely rotates counter-clockwise from the position shown in FIG. 4C to the position shown in FIG. 4D. In this regard FIG. 4D represents a first position and as a worker moves in a counter-clockwise direction around fall protection anchor 10, the lanyard 54 is also shown as moving in a counter-clockwise position from FIG. 4D to FIG. 4E and FIG. 4F. It is also evident that from the position of FIG. 4D, as the worker begins to move counter-clockwise around fall protection anchor 10, connecting device 50 begins to rotate and becomes vertical as shown in FIG. 4E. Upon further counter-clockwise motion of lanyard 54 to the position of FIG. 4F, the connecting device 50 rotates from the vertical position in FIG. 4E to a side position shown in FIG. 4F. It is important to note that in all the positions of FIG. 4D, FIG. 4E and FIG. 4F, an axial force applied along lanyard 54 loads the outer ring of connecting device 50 and not connecting device gate 52. Continued counter-clockwise movement of lanyard 54 from the position shown if FIG. 4F rotates connecting device 50 back to the position shown in FIG. 4A. This prevents improper loading of the connecting device gate 52, binding of the lanyard 54 and rotational locking of the connecting device 50 within the upstanding member 14.

It can be seen from FIGS. 4A through FIG. 4F central upstanding member 14 of fall protection anchor 10 provides self-positioning of connecting device 50 in response to 360 degree movement around fall protection 10, where the connecting device 50 attached through elliptical opening 70 (FIG. 1) overrides upstanding central portion 14 to maintain proper orientation so that a longitudinal force along lanyard 54 loads the ring of connecting device 50 rather than gate 52. While description has been given relative to counter-clockwise movement around fall protection anchor 10, it is readily apparent the same principle applies in clockwise movement going from FIG. 4F to FIG. 4A.

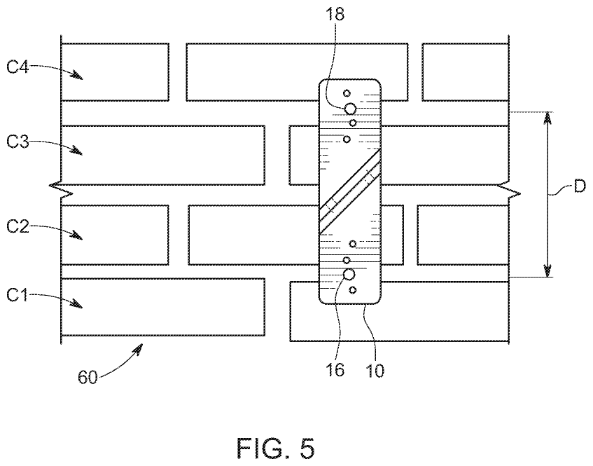

FIG. 5 shows the fall protection anchor 10 attached to a masonry structure 60. Walls of stonework are typically made by laying blocks in a horizonal fashion commonly referred to as a course. A binding material, such as mortar, is applied between and on top of each adjacent block in the course. The process is then repeated with another course of horizontal blocks laid on top of the blocks therebelow. In this manner a pattern of blocks and mortar joints are created. FIG. 5 is exemplary of such a masonry structure 60 shown to have four course C1, C2, C3 and C4. Fall protection anchor 10 is attached to masonry structure 60 by fasteners such as bolts, screws, anchors or similar devices placed through secondary holes 16 and 18. As mentioned previously, secondary hole 16 and secondary hole 18 are spaced apart a distance “D” shown in FIG. 5 as traversing two adjacent courses C2 and C3. In one form of conventional brick masonry construction distance “D” is typically 8 inches. This permits securement of the fasteners placed within secondary holes 16 and 18 to the mortar joints anywhere on the masonry structure 60. While there are four courses shown in masonry structure 60 and fall protection anchor 10 is constructed with distance “D” traversing two courses, one of ordinary skill in the art would recognize that one could vary the distance “D” to traverse a single course or as many courses as is desired. Although it is not particularly desirable, fall protection anchor 10 is fully capable of being attached to the blocks rather than the mortar joints. Referring to FIG. 5, fall protection anchor 10 could be moved vertically half the distance of the distance between adjacent centerlines of courses C2 and C3. This would result in secondary holes 16 and 18 being centered over the blocks in courses C2 and C4 and not the mortar.

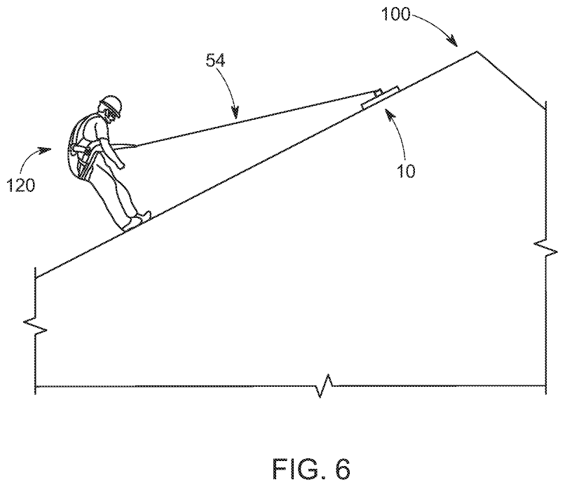

While a preferred embodiment of forming fall protection anchor 10 is set forth with reference to FIGS. 2 and 3, it would be appreciated by one skilled in the art fall protection anchor 10 may be formed in different manner. Fall protection anchor 10 could be cast or molded as a single unitary piece, or 3D printed. Fall protection anchor 10 could be made of separate individually attached pieces. For example; central upstanding member 14 could be made as a single unitary piece joined to a base member 12 made as a different single unitary piece. FIG. 6 depicts one use of the fall protection anchor 10 in an exemplary embodiment where fall protection anchor 10 is attached to a pitched roof 100. A worker wearing a body harness 120 secured to a lanyard 54 attaches the lanyard 54 to the fall protection anchor 10 using the connecting device 50 described above. It would be recognized by one skilled in the art that the pitch of the roof may vary along with the location of attached fall protection anchor 10. In this manner a worker accessing the roof is protected from falls yet mobile to perform tasks at any location on the roof.

The present invention has been described above in terms of various embodiments and as set forth in the detailed illustrations in the attached figures. It will be appreciated by those skilled in the art that various changes and modifications may be made to the embodiments without departing from the spirit or scope of the invention. It is not intended that the invention be limited to the embodiments shown and described. It is intended that the invention include all foreseeable modifications to the embodiments shown and described. Since many embodiments of the invention can be made without departing from the spirit and scope of the invention, the invention resides in the claims hereinafter appended.

What is claimed is:

1. A fall protection anchor for attaching a gated connecting device secured to a lanyard of a body harness used in fall protection systems comprising:
a base member having a longitudinal axis;
an upstanding member projecting from said base member;
said upstanding member having a longitudinal axis and an opening adapted to receive a connecting device attached to a lanyard of a harness system; and
said longitudinal axis of said upstanding member forming an acute angle with said longitudinal axis of said base member whereby said upstanding member provides optimal load bearing resistance.

2. The fall protection anchor of claim 1, further comprising a first connecting portion extending angularly outward from a first section, the juncture of said first section and said first connecting portion defining a bend line wherein said first connecting portion is folded upwardly about said bend line and generally perpendicular to said first section to form said upstanding member.

3. The fall protection anchor of claim 2, further comprising a second section and a second connecting portion extending angularly outward from said second section, the juncture of said second section and said second connecting portion defining a bend line wherein said second connecting portion is folded upwardly about said bend line and generally perpendicular to said second section; said second connecting portion joined to said first connecting portion.

4. The fall protection anchor of claim 3, further comprising a plurality of primary holes in said first section and a plurality of primary holes in said second section, wherein said plurality of primary holes in said first section and said plurality of primary holes in said second section are non-axially aligned.

5. The fall protection anchor of claim 3, further comprising a least one secondary hole in said first section and at least secondary one hole in said second section, wherein said secondary hole in said first section and said secondary hole in said second section are spaced apart a distance equal to the distance between mortar joints in a masonry construction whereby said fall protection anchor is adapted to be attached to a roof substructure or a masonry construction.

6. The fall protection anchor of claim 1, wherein said upstanding member comprises an arch shaped top edge along at least a portion thereof, said arch shaped top edge smoothly curved between opposite ends and equidistantly spaced outwardly from said opening formed in said upstanding member.

7. The fall protection anchor of claim 1, further comprising a first section and a second section, said first section comprising a plurality of primary holes therethrough and said second section comprising a plurality of primary holes therethrough wherein said plurality of holes in said first section and said plurality of holes in said second section are non-axially aligned such that said longitudinal axis of said base member is tangential to each of said plurality of holes.

8. The fall protection anchor of claim 7, wherein said first section further includes at least one secondary hole formed therethrough and said second section comprises at least one secondary hole formed therethrough; said secondary hole in said first section spaced apart from said secondary hole in said second section a distance equal to the distance between mortar joints in a masonry construction whereby said fall protection anchor is adapted to be attached to roof substructure or a masonry construction.

9. The fall protection anchor of claim 1, wherein said opening is elliptical whereby 360 degree movement is permitted of the lanyard around said upstanding member in a manner that prevents binding of the lanyard or loading of a connecting device gate.

10. A fall protection anchor for attaching a gated connecting device secured to a lanyard of a body harness used in fall protection systems comprising:
a substantially flat first section having a longitudinal axis;
a first connecting portion including an opening formed along at least a portion of said first connecting portion;
said first connecting portion angularly extending from said first section relative to said longitudinal axis such that a juncture is formed between said first section and said first connecting portion that defines a bend line;
wherein said first connecting portion is folded upwardly about said bend line and generally perpendicular to said first section.

11. The fall protection anchor of claim 10, further comprising a second section having a longitudinal axis and a second connecting portion annularly extending from said second section longitudinal axis such that a juncture is formed between said second section and said second connecting portion that defines a bend line wherein said second connecting portion is folded upwardly about said bend line and generally perpendicular to said second section.

12. The fall protection anchor of claim 11, said first connecting portion is joined to said second connecting portion to form an upstanding member.

13. The fall protection anchor of claim 12, wherein said upstanding member includes an elliptical opening.

14. The fall protection anchor of claim 13, wherein said upstanding member further comprises an arch shaped top edge along at least a portion thereof, said arch shaped top edge smoothly curved between opposite ends and equidistantly spaced outwardly from an outer edge of said elliptical opening.

15. The fall protection anchor of claim 12, wherein said first section includes at least one hole formed therethrough and said second section includes at least one hole formed therethrough, whereby said fall protection anchor is attachable to a roof substructure.

16. The fall protection anchor of claim 12, wherein said first section includes at least one hole therethrough and said second section includes at least one hole therethrough, said hole in said first section spaced apart from said hole in said second section a distance approximately equal to the distance between mortar joints in a masonry construction whereby said fall protection anchor is adapted to be attached to a masonry construction.

17. A fall protection anchor for attaching a connecting device secured to a lanyard of a body harness used in fall protection systems comprising:
a base member having a longitudinal axis;
an upstanding member projecting from said base member and having a longitudinal axis; and
said upstanding member having an elliptical opening adapted to receive a connecting device attached to a lanyard of a harness system whereby 360 degree movement is permitted of a lanyard around said upstanding member in a manner that prevents binding of the lanyard or loading of a connecting device gate.

18. The fall protection anchor of claim 17, wherein said longitudinal axis of said upstanding member forms acute angle with said longitudinal axis of said base member whereby said upstanding member provides optimal load bearing resistance.

19. The fall protection anchor of claim 17, wherein said base member includes a plurality of holes.

20. The fall protection anchor of claim 17, wherein said upstanding member comprises an arch shaped top edge along at least a portion thereof, said arch shaped top edge smoothly curved between opposite ends and equidistantly spaced outwardly from an outer edge of an elliptical opening formed in said upstanding member.
